(19) United States
(12) Patent Application Publication
(10) Pub. No.: US 2010/0255946 A1
(43) Pub. Date: Oct. 7, 2010

(54) TRACTION CONTROLLER WITH HIDRO-PNEUMATIC ACTUATOR

(76) Inventor: Javier Marcelo JULIA, Mar del Plata (AR)

Correspondence Address: Juan Ignacio Cornidez, Tucuman 3840, Mar del Plata, 7600, AR

(21) Appl. No.: 12/743,606

(22) PCT Filed: Nov. 19, 2008
(86) PCT No.: PCT/ES08/70209

§ 371 Date: May 19, 2010

(30) Foreign Application Priority Data
Nov. 20, 2007 (AR) P-070105154

(51) Int. Cl. F16H 48/20

(52) U.S. Cl. 475/84

(57) ABSTRACT

A hidro-pneumatic piston traction controller is implemented inside a differential (1-2) that contains a pressurized piston (10) in which are situated the planet gears (3) and satellites gears (4) of the differential. The planet gears are in intimated contact with the internal wall of the differential case (1 and 2) by means of the ring gears (6). In case of changing separator (9) by a separator with pistons, the ring gears (6) are in contact with the head of the planet gears (3). The pressure and friction condition inside the differential case do not affect the normal torque transmission lobbied to the wheels; even though the vehicle turns to a high speed, but oppose to the excessive acceleration and speed of some planet gear when the corresponding wheel slides, loosing grip over the asphalt or terrain.

### BACKGROUND OF THE INVENTION

The present invention refers to a hidro-pneumatic piston traction controller for slide control of the differential of a vehicle, making possible the increase of the power transferred between the wheels placed at right and left side of the axis of the differential, when the wheels turn at different angular speeds, and to reduce this way for the vehicle the risks of slipping due to lack of adherence by one of the vehicle's wheels. The invention includes a method and a hidro-mechanic slips control system to control the traction in the differential, allowing a vehicle to apply the traction in a homogeneous form and, in situations of different adherence between one and other wheel, preventing the dissipation of mechanical power due to the sliding of the wheel with lower adherence to the ground. Even in the extreme circumstances of being one of the wheels turning on a very slippery surface, the system canalizes torque through the only wheel that displays adhesion to the ground. The method and the system have application for street vehicles, competition, cargo, agricultural, road machinery, etc . . .

Precedents of the Invention

The classic differentials are usually constituted, by conical gears attached to the differential transmission plate. In a conventional automobile, the differential case has attached an external gear to receive the power transmission from the gearbox, and takes two planet gears and at least one, typically two or eventually more, satellite gears. Each planet gear receives an axle corresponding to one of the right and left wheels whereas the satellite gear(s) make each planet gear to receive the same torque from the motor, even while the wheels turn at different speeds, for example in turns. If any of the wheels of the vehicle loses grip due to slippery road surface the torque is reduced, and the wheel accelerates because the differential reacts and tries to maintain torque. The wheel placed across loses traction because the differential tries to maintain torques equal. What happens in fact is that when a wheel begins to spin in the air, it needs less torque to turn at great speed, and the torque that transmits the differential is reduced.

The other wheel that stays adhered to the asphalt receives the same reduced torque (since the differential always works transmitting the same torque to both sides). Because of this reduction, the transmitted torque is not enough to tract over the asphalt, and the wheel stops. As a consequence, the vehicle loses all mobility and the transmission cannot recover (it slides).

Also it allows us to be able to make extremely tight turns on very adherent surfaces like dry asphalt as if the vehicle did not have any limited slip system and to handle in mud, sand, snow, mountains, asphalt and competition without losing all torque that generates the motor, this cannot be done with the devices existing to date, since if the blockade of the differential is very strong, good traction is achieved in loose grounds but cannot make tight turns; and if the blockade of the differential is loosened to make these turns, traction is lost when the difference of adhesion between the tractor wheels.

The loss of traction in a vehicle can be avoided by using a differential that controls the sliding. Different types of controlled sliding systems are known as, for example, actuated by slopes, by gears, by viscousity, by preloaded springs, driven by air, etc . . . There are also electromechanical systems that electronically detect the asymmetric load (unilateral acceleration) of the wheels and activate a solenoid that controls the sliding causing the planet gears to share a common rotation rate with the differential gear through the pinion gear. The slip control systems display a great complexity and/or a great cost, too high for their insertion in the differential case of a common automobile.

Besides, with today existing devices a totally reliable operation is not obtained under any condition of running. For a good antislip response the blockade of the differential has to be very strong; in these cases traction is good in conditions of loss of adhesion but the system is prone to respond the same way when taking closed turns, when detecting the asymmetricity of the loads that take the right and left wheels, causing an effect of blockade that voids the function of the differential in a situation when it is most justified. This disadvantage can not only cause greater wearing at the tires but can also cause loss of control of the automobile since the maneuverability of the steering wheel is diminished.

### SYNTHESIS OF THE INVENTION

The purpose of the present invention is to produce, in a simple and economic way, an effect of blockade on the corresponding planetary gear to restrain the wheel that is accelerated suddenly or abnormally. The present invention allows avoiding these disadvantages by the use of a hidro pneumatic piston that acts as a brake for the planetary gears. The term “blockade and/or brake” is used in the present description to define an effect of immobilization of the gears lodged within the differential case, so that the turn of these wheels conserves its traction although a wheel tries to go off by lack of adhesion to the road, being the rotation of the differential plate distributed directly to both wheels with the same speed due to the blockade action applied to the planet gears. During the on-speed operation, the planetary gears as well as the satellite gears will not have practically any relative movement when the vehicle is moving in straight line journeys without frights; and little relative movement when it takes a curve or it turns in a corner. All this is relative to the differential plate, since it is the one that turns at the necessary speed to transmit torque to the wheels. But when a wheel loses the grip, the adhesion to the land, the differential continues trying to give same torque while the load that can oppose the wheel has decreased dramatically, thus the wheel tries to increase its speed quickly (it is left “loose”). As the torque transmitted by the differential is reduced but the high resistant load of the other wheel is kept; because it follows adhered to the land normally, this wheel stops since the reduced torque is not enough to turn it. Up to here this is briefly what happens in a normal differential.

The differential system presented in this invention has a friction system in intimate contact with the planet gear and the differential case. Therefore, in the differential of the present invention, in the situation of incipient loss of traction outlined in the previous paragraph, the planet gear corresponding to the “loose” wheel will tend to rotate more rapidly inside the differential case, but resistance is opposed to the acceleration, generated by the hidro pneumatic pistons and the rubbing generated by the intimate contact of the friction system interposed between the planet gear and the differential case. Therefore, the mentioned planet gear is stopped, and the transmitted torque increases sufficiently to support enough traction in the second wheel.

The limited slip device of the present invention includes a preloaded piston with oil contained in the differential of the vehicle. The piston is preloaded to a certain pressure, not so high to impede the correct functioning of the differential in normal kinetic conditions (speed and acceleration), as while making turns on curves (for tight that they might be), but the high enough to produce the effect of limited slip when a wheel looses adherence with the road surface and starts to turn rapidly. The pressure of the piston acts on the free faces of the gear, as this is the one that is placed against the internal wall of the framework, in intimate contact with the above mentioned friction system. The pressure is transmitted to the planet gear inside the differential case, immobilizing it against the internal wall of the differential case due to the intimate contact mentioned before. The breaking effect decelerates the wheel of the vehicle that turns without transmitting traction, and this way it allows the other wheel to produce traction, recovering this way the mobility of the vehicle.

This device works both while applying traction and while breaking allowing that, in case of extreme need, both wheels can remain adhered to the pavement at the same time, not allowing one to slip.

The described device allows, nevertheless, to make extremely tight turns, still on very adherent surfaces as the dry asphalt, as if it did not have any limited slip system, thus allowing full work of the differential function, applying symmetrical torque to wheels with asymmetric loads. Hereby, it allows driving in roads of different type, as mud, sand, snow, mountains and asphalt, having all the time the capability to deliver the whole available engine torque. Because of these characteristics, the system also has utility in differential of vehicles with front traction, without increasing the effort to steer the wheels.

Actually, the piston of the invention can be loaded from outside with oil, being located within the differential case, at normal pressure, and then gas can be introduced to pressurize the oil to the desired magnitude, this way it is the gas what controls the preloaded pressure of of the piston. The combination of a compressible media (the gas) and an incompressible one (the oil) allows to cushion the variations of pressure that occur during the operation, fundamentally by thermometric expansion of the fluid within the differential. In a normal day, the initial room temperature of the oil can be around 20° and rise until 80° after a long trip, which can involve a variation of 50% of the pressure since the volume of the camera and piston are constant and tightly closed, and the hydraulic fluids expand generally between 7 and 8%. In a racing automobile, at the end of a race temperatures in excess of 120° were measured.

The gas (eg. nitrogen) is present within the camera of the piston/s, which has a conduit for loading the oil and gas from the outside, and is lodged within the differential case, mixed within the same oil, and adds a component of pressure to the oil and this one to the piston. From the following detailed description and the attached drawings, several additional characteristics, objectives and advantages of the present invention will become evident, for those understood in these matters,

### BRIEF DESCRIPTION OF THE DRAWINGS

FIG. 1 is an exploded view of a conventional differential system.

FIG. 2 “A”; 2 “B” and 2 “C” is an exploded view of the differential system shown FIG. 1, retrofitted according to the first version of the hidro-pneumatic piston traction controller of the present invention.

FIG. 3 “A” and 3 “B” are another exploded view of the differential system shown FIG. 1, retrofitted according to the first version of the hidro-pneumatic piston traction controller of the present invention.

FIG. 4 is an exploded view of piece 9 with a division 12 in camera 11

FIG. 5 is an exploded view of piece 9 without a division in camera 11.

### DETAILED DESCRIPTION OF THE INVENTION

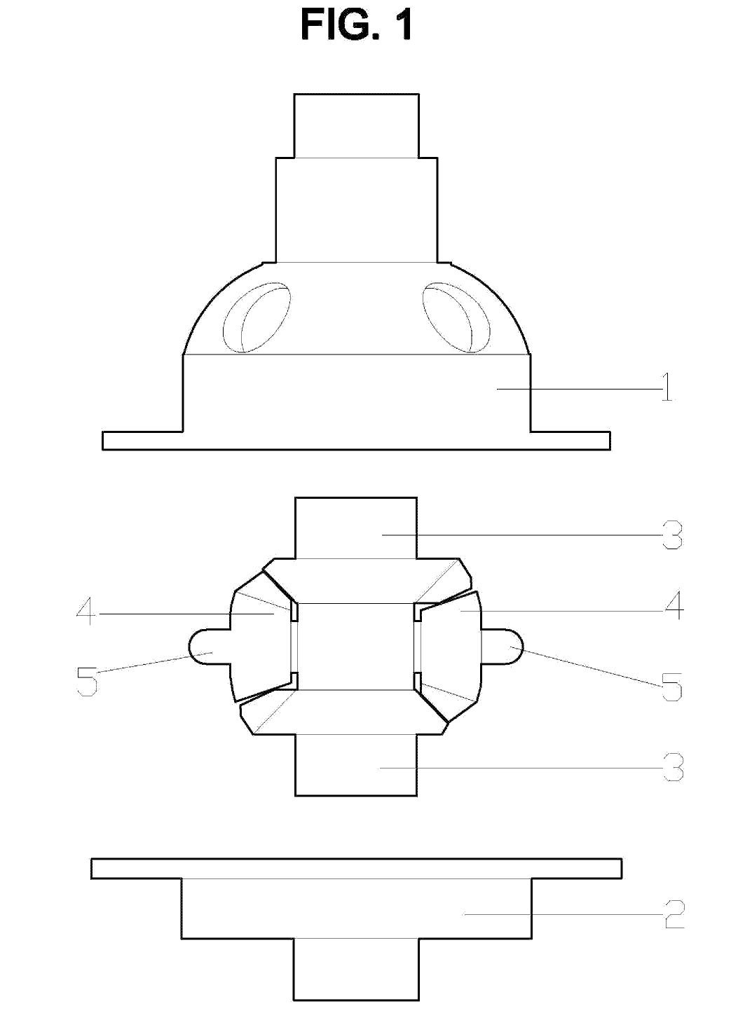

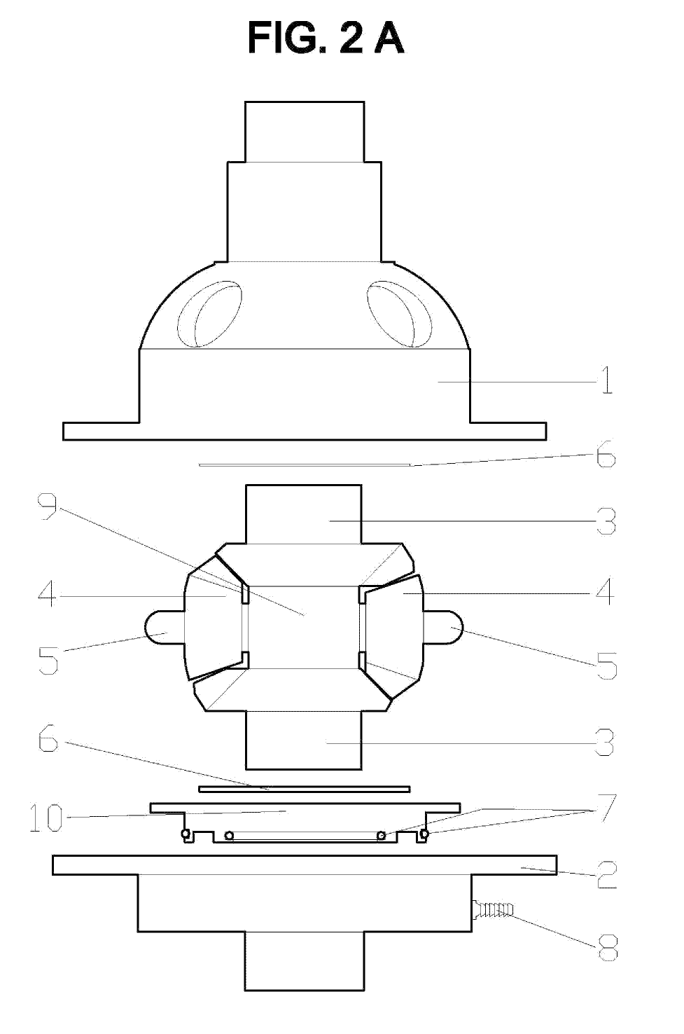

The invention can be applied to already existing differential systems as illustrated in the FIG. 1, which comes from factory as standard equipment for the Ford Ranger. This model carries a one-piece framebox, namely: a differential plate 1 and 2 (in our example with a divided framebox), holding a couple of planet gears 3 facing each other. Every planet gear 3 is internally machined with longitudinal striations to connect an end of the axle shaft that transmits power to a left or right wheel respectively (these are not shown). The differential plates 1 and 2 hold, in addition, a couple of gears facing each other 4, mounted in the same differential case 1 and 2 by means of respective pinion shaft 5. Four gears 3-4 are placed in perpendicular planes, coupling planet gears 3 with satellite gears 4 in a well known and conventional way.

The whole set 1-2-3-4 turns at the speed of the wheels when this is equal in both wheels for the vehicle moving in straight line, while the first four gears are practically without relative movement to the differential case 1 and 2. When the vehicle makes a turn, the outside wheel will travel a longer distance than the inside does, so that both planet gears 3 will have to rotate at different speeds, so that the wheels of the vehicle follow its traveling, and the difference is compensated by the satellites 4 that rotate at slow speed about its pinion shaft 5.

The problem that solves the present invention shows up when one of the wheels loses adherence and monopolizes the whole available torque, which is excessive for the small load that opposes the loose wheel, losing the opposite wheel all traction (this is the “good one”) in spite of being kept firmly adhered on the asphalt or ground, as previously explained.

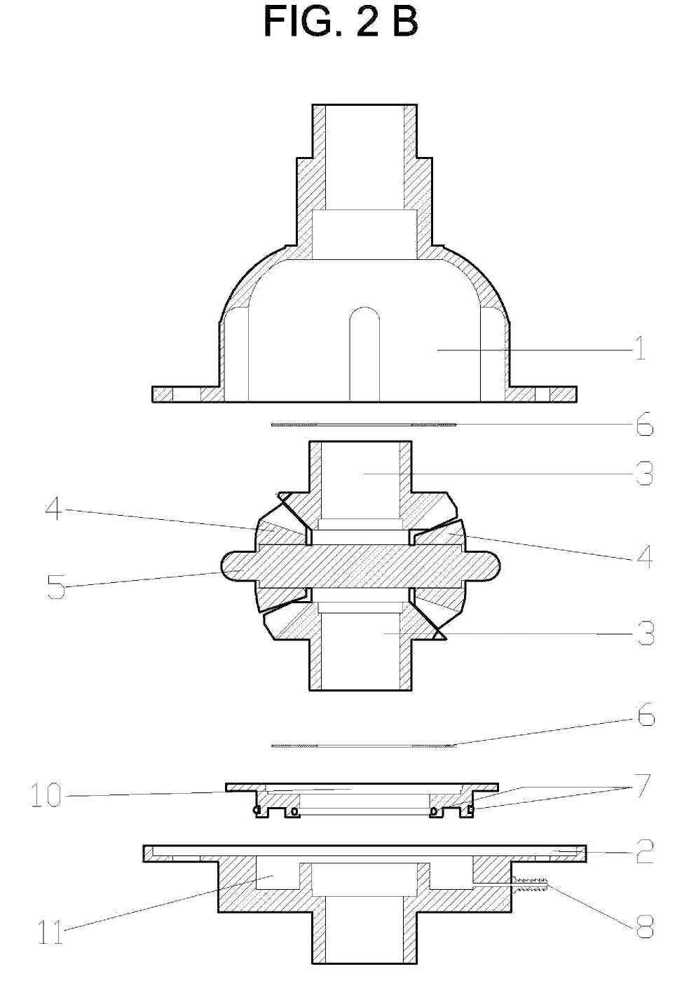

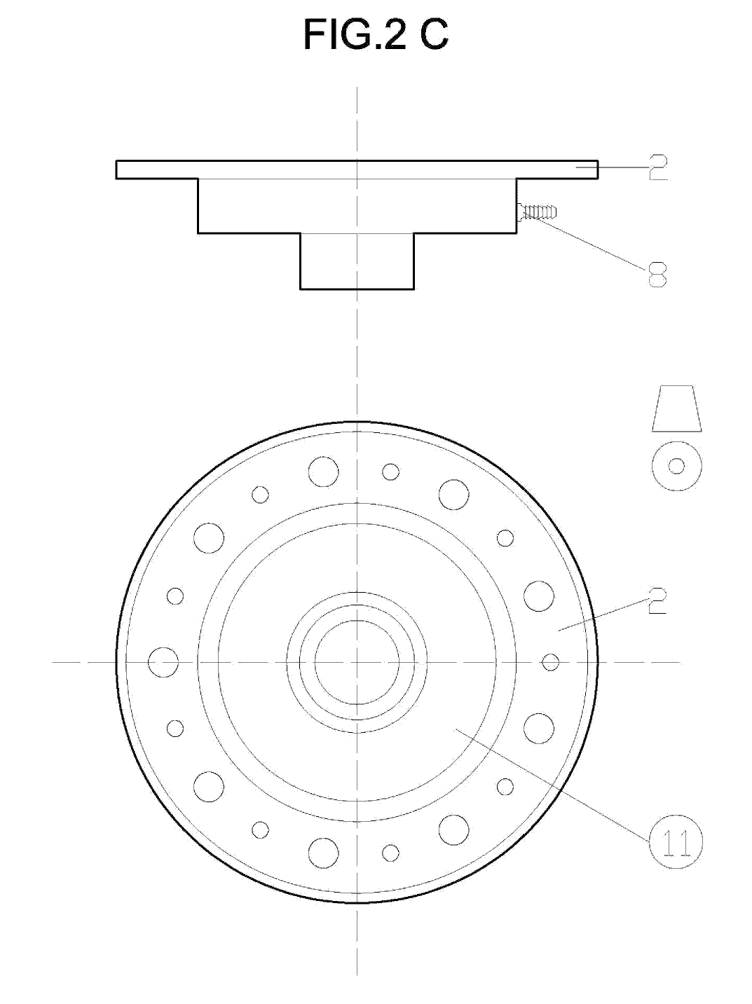

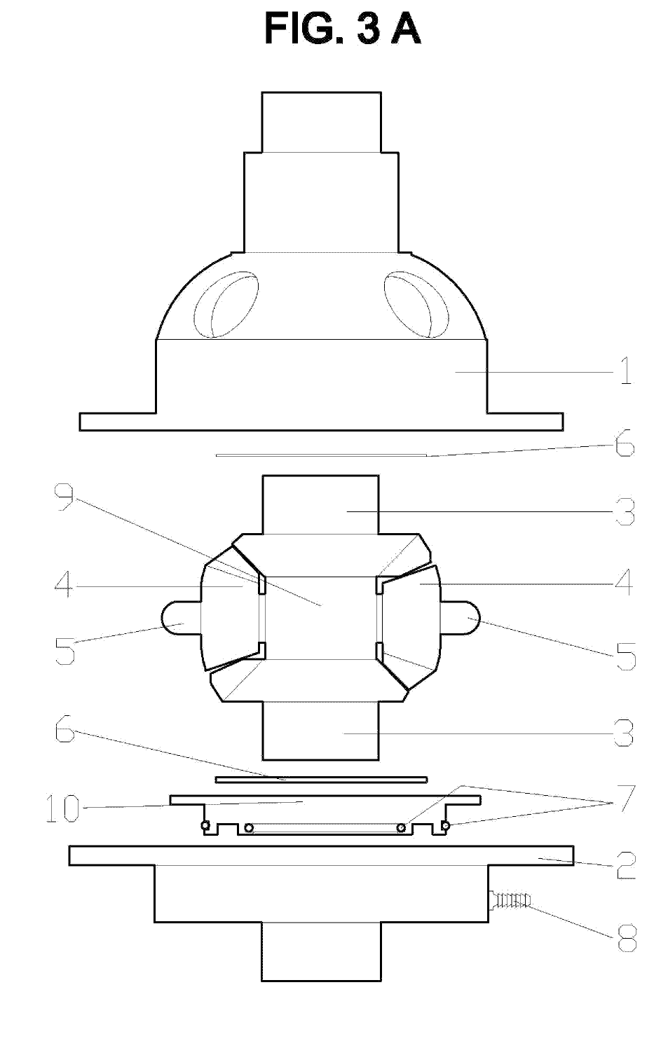

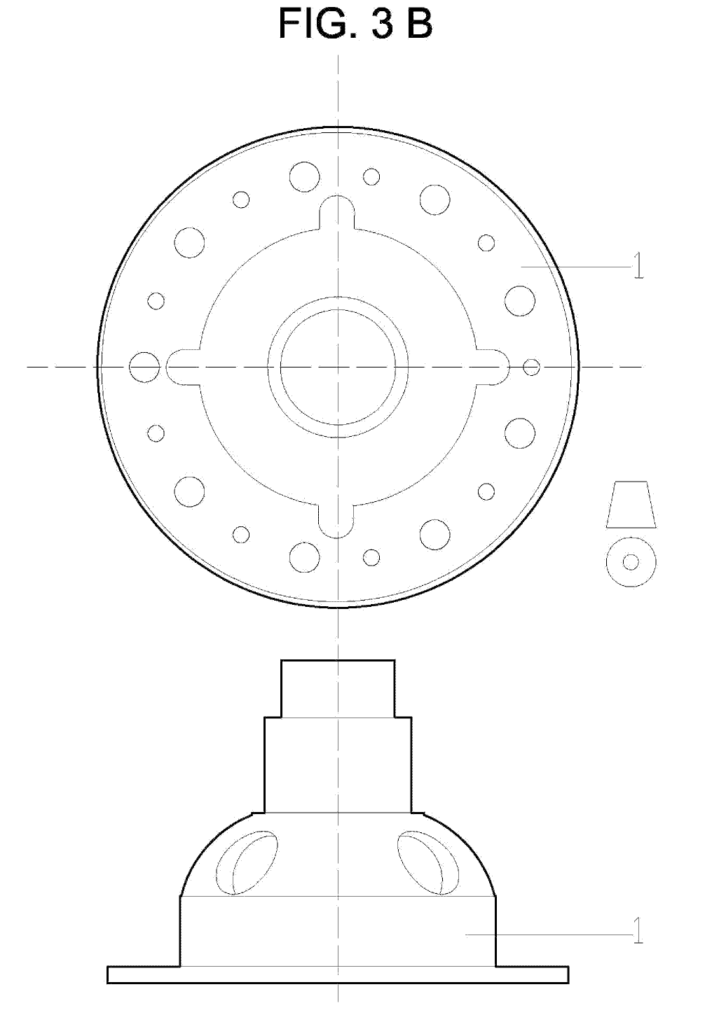

According to the details of the present invention shown in FIG. 2 “A”; 2 “B”; 2 “C”; 3 “A” and 3 “B”, a sealed cavity 11 is machined in the inside of frame 2. A nipple 8 is placed at the lid of the framework 2, and used to enter oil (or hydraulic fluid) at ambient pressure, the groove is covered with the piston 10 and the seal 7, finishing when the frame 1 and 2 are put together. Previously, ring gears 6 are placed in front of each planet gear 3, so they are pressed against the frame 1-2 when the pressure of the piston 10 increases, braking the gears.

A part of the cavity 11 volume is filled with nitrogen gas, which fulfills the double function of pressurizing the oil and compensating the variations of the pressure due to temperature changes typical of the differential operation.

In the alternative schematics of the FIG. 2 “A”; 2 “B”; 2 “C”; 3 “A” and 3 “B”, the nitrogen is introduced through the same nipple 8 as does the oil, and both are mixed inside the sealed chamber 11, closed by piston 10 and seals 7, as a pressurized mixture.

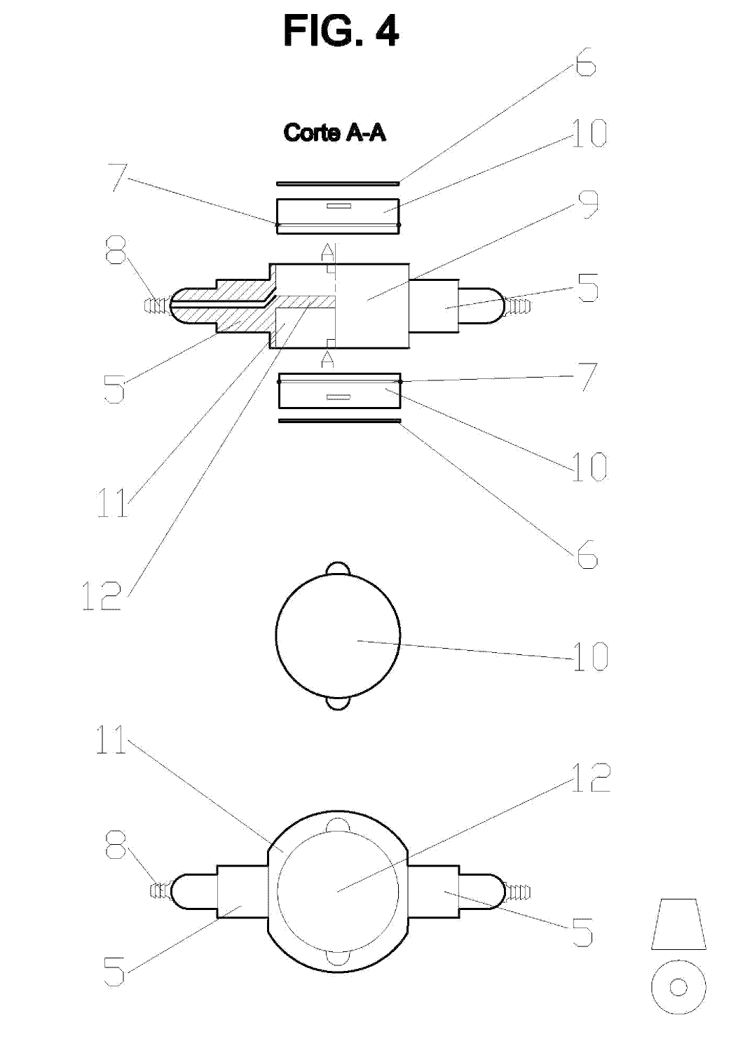

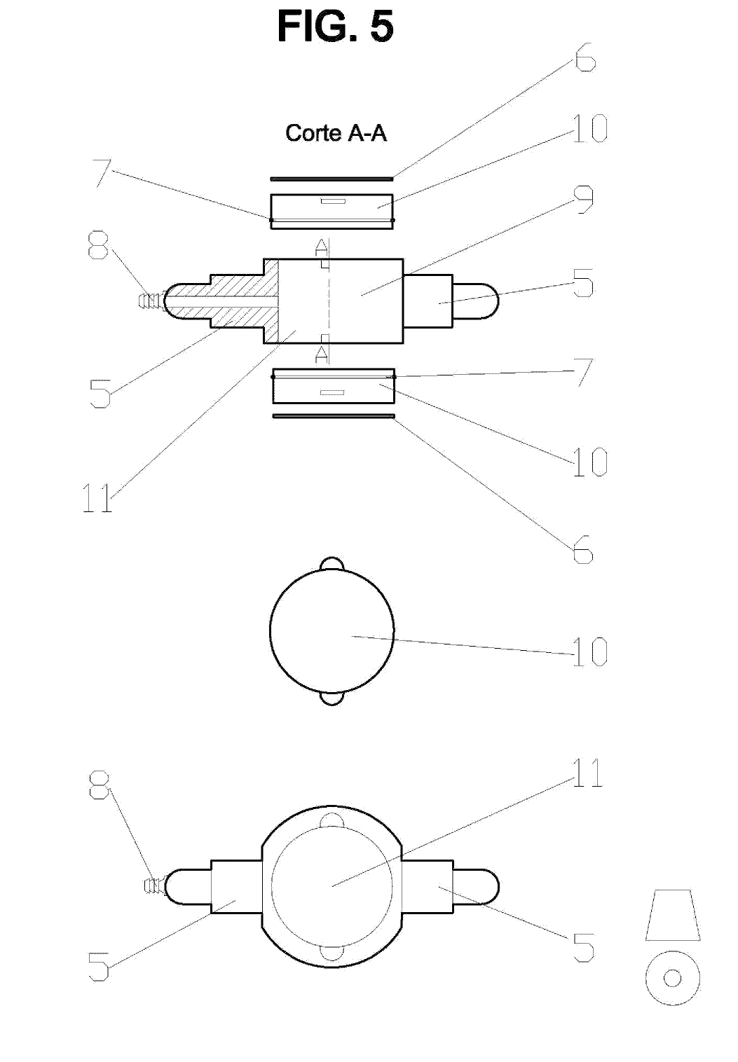

Also the relative positions of piston 10, the cavity 11, the seals 7 and nipple 8 can be changed, as can be seen in FIGS. 4 and 5 where the pistons 10 are inserted in the separator 9 which applies pressure to the ring gear 6 against the head of the planet gear 3, causing the breaking effect. The pinion shafts 5 are threaded and one of them holds the load nipple 8. The separator 9 can be divided into two sealed cavities by a separator 12, keeping independent the pistons 10; as can be seen in FIG. 4 and/or not having separation as shown in FIG. 5.

Even while the invention has been described in terms of a preferred design, it must be understood that our intention is not to limit the invention to the shown design. The invention can be used for self-propelled vehicles, from low to high engine power, by adapting the values for the pressure used for every particular case. We acknowledge that people trained in this subject will be able to realize that replacements, alterations, modifications and omissions can be done without departing from the spirit or basic idea of the invention. Therefore, the previous description is taken as a showcase only, and the invention includes every reasonable design compatible with the object of the invention, and without limiting the scope of the invention.

1. A hidro-pneumatic piston traction controller that can be mounted on a vehicle to transmit power to the vehicle wheels, including the differential a differential plate (1 and 2) made to receive power and torque and equipped with at least a satellite gear (4) connected with at least two planetary gears (3) made to transmit power to the above mentioned wheels, characterized by using one or more hidro-pneumatic pistons that apply pressure over the planet gears so as to resist any excessive acceleration or speed that any of those planet gears may take when the wheel linked to the planet gears may experience an important decrease of load, by blocking the differential so both planet gears turn substantially to the same speed.

2. The hidro-pneumatic piston traction controller method of the claim 1, distinguished because the above mentioned excessive acceleration or speed is substantially larger than that of the planetary gears relative to the differential case when the vehicle turns normally for a tight turn.

3. The hidro-pneumatic piston traction controller method if claim 1 or 2, distinguished because the pressurized media includes a lubricant liquid (including fats) filling the cavity 11 that contains the piston 10 that causes the breaking

4. The hidro-pneumatic piston traction controller method of the claim 3, distinguished because the pressure values applied to the liquid encompass the interval from 32 to 41 lbs/pulg.

5. The hidro-pneumatic piston traction controller method of the claim 3 or 4, distinguished because the liquid is pressurized by means of a gas.

6. The hidro-pneumatic piston traction controller method of the claim 5, distinguished because the gas used is nitrogen.

7. A differential with hidro-pneumatic piston traction controller for the vehicles' wheels, that includes a differential plate (1 and 2), made to receive power and torque, possessing at least one satellite gear (4) coupled with at least two planetary gears (3) made to transmit power to the wheels. The system is distinguished because those planetary gears are separated by a solid piece 9 and are also coupled to a friction device (ring gears) (6) pressed by one or more pistons 10 that contain a pressurized liquid capable of applying blocking pressure to press the planet gears against those friction devices; and also the friction devices against the plates 1 and 2. By applying the pressure it stops the increase of speed or acceleration that indicates incipient lost of traction in one of the wheels, and the pressure also blocks the differential so both planet gears turn substantially at the same speed.

8. The differential with hidro-pneumatic piston traction controller of claim 7, distinguished because the piston/s is/are inside the differential case.

9. The differential with hidro-pneumatic piston traction controller of claim 7, distinguished because the liquid used is oil or hydraulic fluid (including fats).

10. The differential with hidro-pneumatic piston traction controller of claims 7; 8 ó 9, distinguished because the liquid is pressurized by a gas.

11. The differential with hidro-pneumatic piston traction controller of claim 10, distinguished because the gas is nitrogen.

12. The differential with hidro-pneumatic piston traction controller of claim 11, characterized because the gas is contained inside a chamber (10, 7 and 11) located inside the above mentioned differential case (1 and 2).

13. The differential with hidro-pneumatic piston traction controller of claim 12, distinguished because the separator unity 9 can be one solid piece.

14. The differential with hidro-pneumatic piston traction controller of claim 11, distinguished because the gas and the liquid are mixed together under pressure.

15. The differential with hidro-pneumatic piston traction controller of claim 13, distinguished because the planetary gears separator unity 9 can be replaced by another one that has two pistons 10, that make pressure over the planetary gears surface 3.

16. The differential hidro-pneumatic piston traction controller of any claim from claims 7 to 15, distinguished because the pressure value applied to the liquid in the pistons is encompassed in the interval of 32 to 41 lbs/pulg.

17. The differential hidro-pneumatic piston traction controller of any claim from claims 7 to 16, distinguished because the friction device includes ring gears (6) inserted between each planet gear and the inner wall of the differential plate, making sliding contact with both.

18. The differential with hidro-pneumatic piston traction controller of any claim from claims 7 to 17, distinguished because the friction device includes the respective ring gears (6) inserted between each planet gear and the inner wall of the differential case in sliding contact with both, adding to this the separator (9) which contains two ring gears (6) acting on the planet gear heads (3), all of them pressed by the pistons of separator (9).

19. The use of the differential with hidro-pneumatic piston traction controller of any claim from claims 7 to 18 in a passenger or cargo vehicle.

20. The use of the differential with hidro-pneumatic piston traction controller of any claim from claims 7 to 18 in a racing vehicle.

21. The use of the differential with hidro-pneumatic piston traction controller of any claim from claims 7 to 18 in a road-building or agriculture laboring machinery.
